(19) United States
(12) Patent Application Publication
(10) Pub. No.: US 2016/0139616 A1
(43) Pub. Date: May 19, 2016

(54) Valve Actuation Using Shape Memory Alloy

(71) Applicants: Khedher Mellah, Sugar Land, TX (US); Baha T. Tanju, Houston, TX (US)

(72) Inventors: Khedher Mellah, Sugar Land, TX (US); Baha T. Tanju, Houston, TX (US)

(73) Assignee: Chevron U.S.A. Inc., San Ramon, CA (US)

(21) Appl. No.: 14/543,521

(22) Filed: Nov. 17, 2014

(51) Int. Cl. G05D 23/08; F16K 17/04

(52) U.S. Cl. CPC G05D 23/08; F16K 17/04

(57) ABSTRACT

An actuator device includes a shape memory alloy (SMA) device comprising an two way SMA element transformable from a deformed shape to a pre-deformed shape at a temperature of the SMA element that is above a transition temperature of the SMA element. The actuator device further includes a valve having an opening therethrough. The valve is moveable between an open position and a closed position. The actuator device also includes a biasing element. The valve is positioned between the SMA device and the biasing element. The SMA element is substantially cone-shaped, and a wall of the SMA element is slanted down at an angle that is between approximately 40 degrees and approximately 90 degrees relative to a vertical axis extending through the wall.

### TECHNICAL FIELD

The present disclosure relates to valves that are used in downhole operations and more particularly to opening and closing of such valves based on temperature.

### BACKGROUND

Valves are commonly used in wellbores to control fluid flow through tubing installed in the wellbores. One application of such valves is in steam-assisted gravity drainage (SAGD) method of producing hydrocarbons. SAGD is a method of thermally recovering hydrocarbons using spaced horizontal well pairs. The SAGD process utilizes horizontal well-pairs that are drilled with about 5 m of vertical separation. The lower production well is drilled close to the bottom of the zone of interest. Steam is injected in the upper injection well. Steam injection generates a high-temperature vapor chamber which heats the surrounding bitumen, allowing it to drain by gravity into the lower production well blow.

In SAGD, there three stages of steam injection that happen at different temperatures. The steam is pumped through both wells during the first stage also known as the preheat stage. The injected steam forms a steam chamber around the injection well and above the production well. Once the cavity is established, the second stage, production stage, starts and the bottom well is turned into a producer and steam continue to be injected in the upper wells at a different temperature than the first stage. When the cavity is fully formed, oil production continues at the third stage or reservoir blowdown stage.

To illustrate, as the steam chamber expands around the injection well, hydrocarbons in the reservoir are heated such that the heated hydrocarbons flow, due to gravitational force, toward the production well that is below the injection well. The hydrocarbons that flow toward the production well are then produced through the production well.

The steam chamber starts to form during a pre-heat stage of the SAGD process. At the start of the pre-heat stage, both the injection well and the production well may be used to pump steam in order to heat the hydrocarbons in the reservoir. Steam may continue to be pumped into both the production well and the injection well until satisfactory fluid communication is established between the wells. The establishment of the fluid communication between the wells helps the downward flow of hydrocarbons from the reservoir to the production well once production starts. The pumping of steam down the production well ceases once a fluid communication is established between the injection well and the production well. Use of the production well for the production of hydrocarbon starts after the use of the production well for steam injection ceases.

In some cases, valves may be used to control the amount of steam and/or the rate of steam flow to the reservoir. For example, the steam flow may be controlled using valve(s) in order to control to the size of the steam chamber. To illustrate, opening and/or closing valves may require intervention to transition the production well from use to inject steam to production use.

Thus, devices and methods that allow opening and closing of valves without the need for intervention are desirable.

### SUMMARY

The present disclosure relates to subsurface valves that are used in downhole operations and more particularly to opening and closing of such valves based on temperature. In an example embodiment, an actuator device includes a shape memory alloy (SMA) device comprising a two way SMA element transformable from a deformed shape to a pre-deformed shape at a temperature of the SMA element that is above a transition temperature of the SMA element and within a temperature range above the transition temperature. The actuator device further includes a valve having an opening therethrough. The valve is moveable between an open position and a closed position. The actuator device also includes a biasing element. The valve is positioned between the SMA device and the biasing element. The SMA element is substantially cone-shaped, and a wall of the SMA element is slanted down at an angle that is between approximately 40 degrees and approximately 90 degrees relative to a vertical axis extending through the wall.

In another example embodiment, an actuator device disposed annularly around a tubing includes a shape memory alloy (SMA) device that includes an two way SMA element transformable from a deformed shape to a pre-deformed shape at a temperature of the SMA element that is above a transition temperature of the SMA element. The actuator device further includes a valve having an opening therethrough. The valve is moveable between an open position and a closed position by changing temperature around SMA transition temperature. The actuator device also includes a biasing element. The valve is positioned between the SMA device and the biasing element. The SMA element is substantially cone-shaped, and a wall of the SMA element is slanted down at an angle that is between approximately 40 degrees and approximately 90 degrees relative to a vertical axis extending through the wall. When the SMA element transforms from the deformed shape to the deformable shape, the SMA element pushes the valve element toward the bias element such that the opening of the valve aligns with an opening of the tubing.

These and other aspects, objects, features, and embodiments will be apparent from the following description and the appended claims.

### BRIEF DESCRIPTION OF THE DRAWINGS

Reference will now be made to the accompanying drawings, which are not necessarily drawn to scale, and wherein:

FIGS. 1A-1C illustrate cross-sectional views of an actuator device annularly attached to a tubing according to an example embodiment;

FIGS. 2A-2B illustrate cross-sectional views of an actuator device annularly attached to a tubing according to another example embodiment;

FIG. 3 illustrates a cross-sectional view of an actuator device annularly attached to a tubing according to another example embodiment;

FIGS. 4A-4B illustrate different views of a shape memory alloy element that may be used in the actuator device of FIGS. 1A-C, FIGS. 2A-B and FIG. 3 according to an example embodiment;

FIG. 5 illustrates outline views of two states of the shape memory alloy element of FIGS. 4A-4B according to an example embodiment;

FIG. 6 illustrates a series of the shape memory alloy elements of FIGS. 4A-4B according to an example embodiment;

FIG. 7 illustrates a cross-sectional view of a shape memory alloy element that may be used in the actuator device of FIGS. 1A-C, FIGS. 2A-B and FIG. 3 according to another example embodiment;

FIG. 8 illustrates series of the shape memory alloy element of FIG. 7 according to an example embodiment; and

FIG. 9 illustrates a side view of injection and production wells in a SAGD operation that uses the actuator device of FIGS. 1A-C, FIGS. 2A-B and/or FIG. 3 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DETAILED DESCRIPTION OF THE EXAMPLE EMBODIMENTS

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

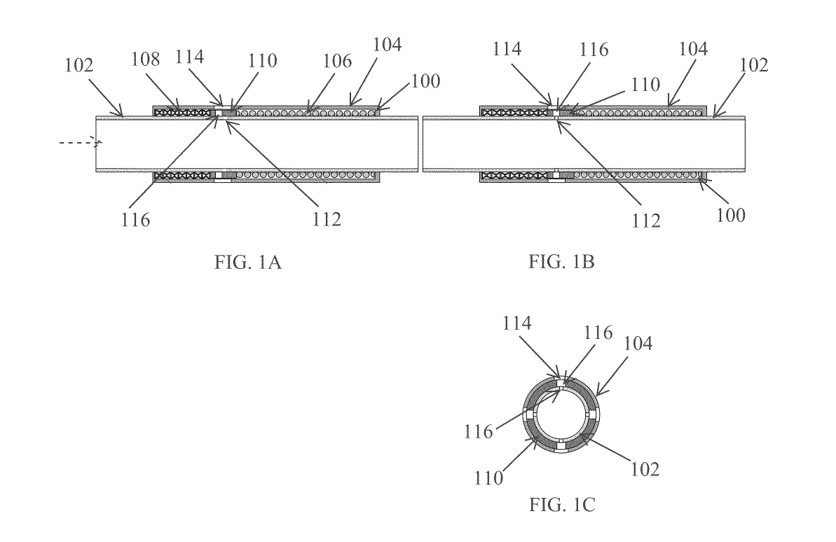

Turning now to the drawings, FIGS. 1A-1C illustrate cross-sectional views of an actuator device 100 annularly attached to a tubing 102 according to an example embodiment. The actuator device 100 includes an enclosure 104, a spring 106, and a valve 110, and a shape memory alloy (SMA) device 108. FIG. 1A illustrates the valve 110 in a closed position, and FIGS. 1B and 1C illustrate the valve 110 in an open position. As illustrated in FIGS. 1A-1C, the actuator device 100 is disposed around the tubing 102. The tubing 102 includes an opening 112. The enclosure 104 includes an opening 114, and the valve 110 includes another opening 116. The enclosure 104 may also have another opening on a side of the enclosure 104 that is in contact with the surface of the tubing 102, wherein the opening is aligned with the opening 112 of the tubing 102. Fluid is allowed to flow in and/or out of the tubing 102 through the valve 110 when the valve 110 slides to an open position such that the openings 112, 114, 116 are lined up providing a passageway between the inside of the tubing 102 and the outside of the tubing 102.

In some example embodiments, the enclosure 104 is fixedly attached to the outside surface of the tubing 102 and encloses the spring 106, the SMA device 108, and the valve 110. For example, the enclosure 104 may be made from a material that can be reliably used in a high temperature (e.g., 250° C.) and high pressure downhole environment that is encountered in typical oil and gas operations.

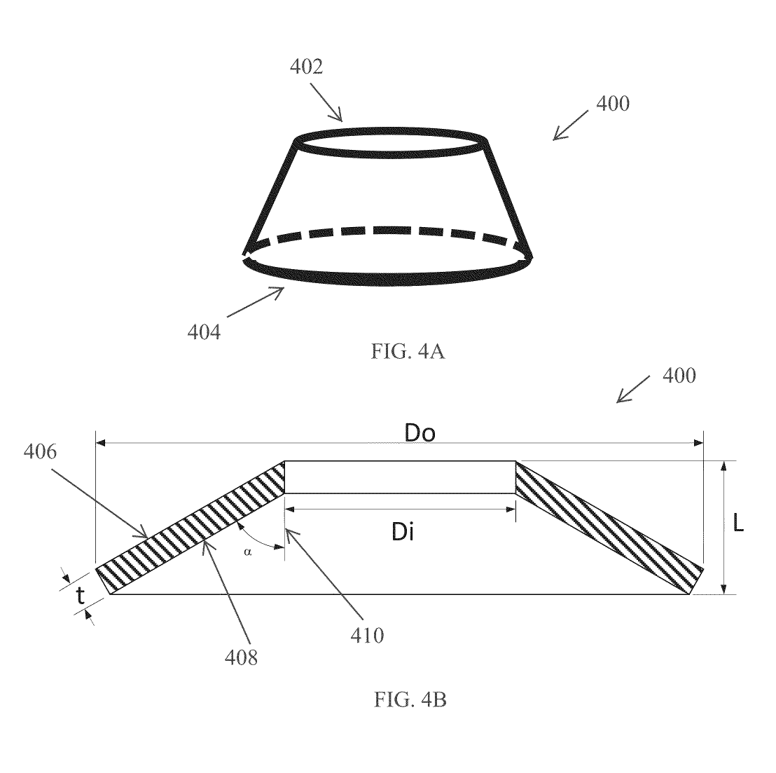

In some example embodiments, the valve 110 is slidable between the closed position shown in FIG. 1A and the open position shown in FIG. 1B. For example, the SMA device 108 may be made from a two way shape memory alloy that maintains its deformed shape below a transition temperature (e.g., 180° C.) and changes back to its original shape above the transition temperature and within a temperature range above the transition temperature. For example, the deformed shape may be a contracted shape, and the original (pre-deformed) shape may be an expanded shape. As another example, the deformed shape may be an expanded shape, and the original shape may be a contracted shape. The SMA device 108 may be made from a material such as NiTiPd alloy. The SMA device 108 can be arranged such that valve 110 opens or closes at only certain target temperature range. The SMA hysteresis and transition temperature range can be controlled by adding (mixing) amounts of different elements (e.g., hafnium, palladium, platinum) in the alloy. In some example embodiments, SMA elements (such as the SMA element 400 shown in FIGS. 4A and 4B) that have different transition temperatures or temperature ranges can be stacked (i.e., use together) to achieve desired opening or closing of the valve 110.

In some example embodiments, the SMA device 108 may be placed in the actuator device 100 in a contracted form, which, for example, may be a deformed shape of the SMA device 108. In an illustrative example, a fluid (e.g., steam) may flow through the tubing 102 in the direction shown by the dotted arrow in FIG. 1A. If the temperature of the fluid is too low to heat the SMA device 108 above the transition temperature of the SMA device 108, the SMA device 108 may maintain its contracted position, and thus, may not exert any additional force on the valve 110. However, if the fluid flowing through the tubing 102 is at a temperature or reaches a temperature that heats the SMA device 108 to above the transition temperature of the SMA device 108, the SMA device 108 may expand and exert additional force on the valve 110.

To illustrate, because the enclosure 104 prevents the SMA device 108 from expanding in a direction away from the valve 110, the SMA device 108 expands toward the valve 110, thereby exerting a force against the valve 110. In some example embodiments, the expansion of the SMA device 108 induces a movement of the valve 110 toward the spring 106 such that the opening 116 of the valve 110 lines up with both the opening 112 of the tubing 102 and the opening 114 of the enclosure 104 (for example, as shown in FIG. 1B). Alternatively, the valve 110 may be in an open position (such as shown in FIG. 1B) prior to the expansion of the SMA device 108 due to heat transfer from the fluid flowing in the tubing 102. In such cases, the expansion of the SMA device 108 may induce a movement of the valve 110 toward the spring 106 such that the opening 116 of the valve 110 misaligned with the opening 112 of the tubing 102. The spring 106 serves as a biasing element that can exert a force against the valve 110.

In some alternative embodiments, the SMA device 108 may have an expanded shape (i.e., the deformed shape) when originally placed in the actuator device 100. Thus, when the SMA device 108 is heated above the transition temperature of the SMA device 108, the SMA device 108 may contract. The contraction of the SMA device 108 may result in the valve 110 sliding toward the SMA device 108 due to the force exerted by the spring 106. For example, the valve 110 may slide to a closed position shown in FIG. 1A, where the opening 116 of the valve 110 does not line up with the opening 112 of the tubing 102. Alternatively, the valve 110 may originally be in a closed position and may slide to an open position (such as shown in FIG. 1B), where the opening 116 of the valve 110 lines up with both the opening 112 of the tubing 102 and the opening 114 of the enclosure 104.

As illustrated in FIGS. 1A-1C, the actuator device 100 may include multiple valves 110 that may line up with corresponding openings in the tubing 102 and the enclosure 104. For example, the actuator device 100 may include four valves as more clearly illustrated in FIG. 1C. In some alternative embodiments, the actuator device 100 may include just one valve or more multiple valves without departing from the scope of this disclosure.

Although FIGS. 1A and 1B illustrate a spring 106 as a biasing component, in alternative embodiments, another biasing component or another type of spring may be used in the actuator device 100. The relative positions of the openings 112, 114, 116 shown in FIGS. 1A-1C are illustrative examples, and in alternative embodiments, may be different than shown. The enclosure 104, the spring 106, the SMA device 108, and the valve 110 may be made from materials that are reliably usable in a downhole environment that is commonly encountered in oil and gas operations as known to those of ordinary skill in the art with the benefit of the present disclosure.

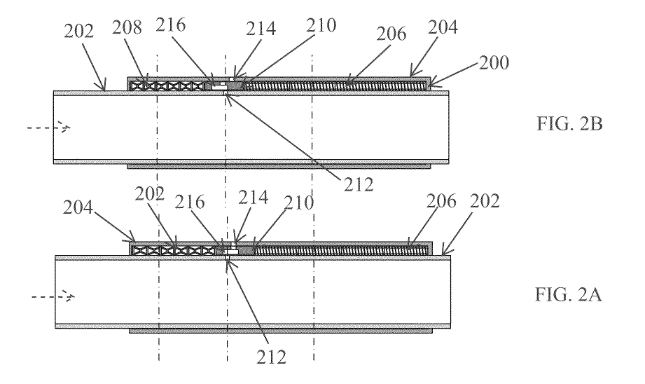

FIGS. 2A-2B illustrate cross-sectional views of an actuator device 200 annularly attached to a tubing 202 according to another example embodiment. The actuator device 200 includes an enclosure 204, a spring 206, and a valve 210, and an SMA device 208. FIG. 2A illustrates the valve 210 in an open position, and FIG. 2B illustrates the valve 210 in a closed position.

As illustrated in FIGS. 2A and 2B, the actuator device 200 is disposed around the outer surface of the tubing 202. The tubing 202 includes an opening 212. The enclosure 204 includes an opening 214, and the valve 210 includes an opening 216. Fluid is allowed to flow in and/or out of the tubing 102 through the valve 210 when the openings 212, 214, 216 are lined up providing a passageway between the inside of the tubing 202 and the outside of the tubing 202, such as a hydrocarbon reservoir.

In some example embodiments, the enclosure 204 is fixedly attached to the outside surface of the tubing 202 and encloses the spring 206, the SMA device 208, and the valve 210. For example, the enclosure 204 may be made from a material that can be reliably used in a high temperature (e.g., 250° C.) and high pressure downhole environment that is encountered in typical oil and gas operations.

In some example embodiments, the valve 210 is slidable between the open position shown in FIG. 2A and the closed position shown in FIG. 2B. For example, the SMA device 208 may be made from a shape memory alloy that maintains its deformed shape (e.g., expanded shape) below a transition temperature and changes back its original (pre-deformed) shape above the transition temperature. In some alternative embodiments, the deformed shape may be a contracted shape, and the pre-deformed shape may be the expanded shape, (i.e., expanded as compared to the deformed shape). The SMA device 208 may be made from a material such as NiTiPd alloy.

In some example embodiments, the SMA device 208 may be placed in the actuator device 200 in an expanded form, which, for example, may be a deformed shape of the SMA device 208. To illustrate, the valve 208 may be in an open position as shown in FIG. 2A. For example, a fluid (e.g., steam) may flow through the tubing 202 in the direction shown by the dotted arrow in FIG. 2A. If the temperature of the fluid is too low to heat the SMA device 208 above the transition temperature of the SMA device 208, the SMA device 208 may maintain its expanded position, and thus, maintain the force the SMA device 208 exerts on the valve 210. However, if the fluid flowing through the tubing 202 is at a temperature or reaches a temperature that heats the SMA device 208 to above the transition temperature of the SMA device 208, the SMA device 208 may contract and provide a space for the valve 210 to move toward the SMA device 208.

To illustrate, when the SMA device 208 contracts away from the valve 210 and/or from the wall of the enclosure 204, space becomes available for the valve 210 to slide toward the SMA device 208 because of the biasing force exerted on the valve 210 by the spring 206. The movement of the valve 210 toward the SMA device 208 may result in, for example, the opening 216 of the valve 210 being misaligned with the opening 214 of the enclosure 214, which puts the valve 210 in a closed position, such as shown in FIG. 2B.

In some alternative example embodiments, when the valve 210 is in a closed position (such as shown in FIG. 2B) prior to the expansion of the SMA device 208, the contraction of the SMA device 208 can induce a movement of the valve 210 away from the spring 206 such that the opening 216 of the valve 210 lines up with both the opening 212 of the tubing 202 and the opening 214 of the enclosure 204, for example, as shown in FIG. 2B.

In some alternative embodiments, the SMA device 108 may have a contracted shape (i.e., the deformed shape) when originally placed in the actuator device 200. Thus, when the SMA device 208 is heated above the transition temperature of the SMA device 208, the SMA device 208 may expand, resulting in the valve 210 sliding toward the spring 206 due to the force exerted by the SMA device 208. For example, the valve 210 may slide to a closed position, where the opening 216 of the valve 210 does not line up with the opening 214 of the enclosure 204. Alternatively, the valve 210 may originally be in a closed position and may slide to an open position (such as shown in FIG. 2A), where the opening 216 of the valve 210 lines up with both the opening 212 of the tubing 202 and the opening 214 of the enclosure 204.

In the embodiments shown in FIGS. 2A and 2B, the actuator device 200 may include a single valve 210, for example, for use with a production well. In some alternative embodiments, the actuator device 200 may include two or more valves that are spread angularly around the actuator device 200. The enclosure 204, the spring 206, the SMA device 208, and the valve 210 may be made from materials that are reliably usable in a downhole environment that is commonly encountered in oil and gas operations as known to those of ordinary skill in the art with the benefit of the present disclosure.

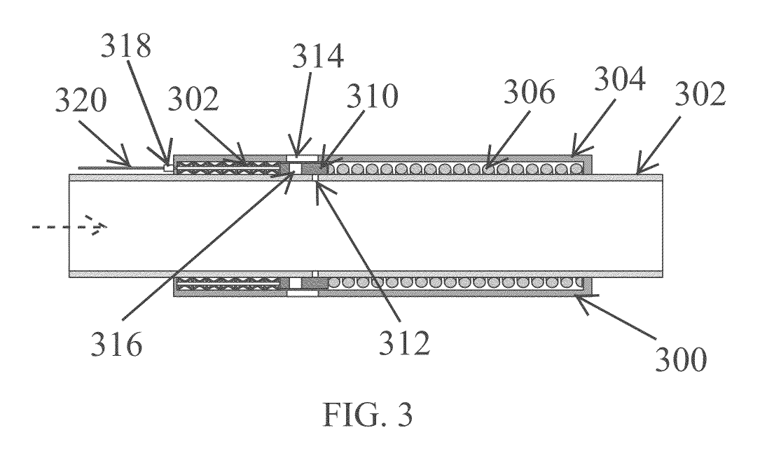

FIG. 3 illustrates a cross-sectional views of an actuator device 300 annularly attached to a tubing 302 according to another example embodiment. The actuator device 300 includes an enclosure 304, a spring 306, and a valve 310, and a shape memory alloy (SMA) device 308. As illustrated in FIG. 3, the actuator device 300 is disposed around the tubing 302. The tubing 302 includes an opening 312. The enclosure 304 includes an opening 314, and the valve 310 includes another opening 316. Fluid is allowed to flow in and/or out of the tubing 302 through the valve 310 when the openings 312, 314, 316 are lined up providing a passageway between the inside of the tubing 302 and the outside of the tubing 302 such as a hydrocarbon reservoir. Similar to the actuator device 100, 200, fluid is blocked from flowing in or out of the tubing 302 through the valve 310 if the opening 316 of the valve is misaligned fully with one or both of the openings 312, 314.

The actuator device 300 operates in the similar manner described with respect to the actuator devices 100, 200. The actuator device 300 also includes an electrical connector 318 for connecting one or more electrical wires 320 with the SMA device 308 or another device that generates heat to increase the temperature of the SMA device 308, for example, above the transition temperature of the SMA device 308. To illustrate, one or more electrical wires 320 may be connected to a power supply that induces a current to flow through the SMA device 308 such that temperature of the SMA device 308 increases above the transition temperature that results in the SMA device 308 changing from a deformed (e.g., contracted or expanded) shape to a pre-deformed (e.g., expanded or contracted) shape. The actuator device 300 may be made from materials that are reliably usable in a downhole environment that is commonly encountered in oil and gas operations as known to those of ordinary skill in the art with the benefit of the present disclosure.

FIGS. 4A-4B illustrate different views of a shape memory alloy (SMA) element 400 that may be used in the actuator devices of FIGS. 1A-C, FIGS. 2A-B and FIG. 3 according to an example embodiment. In some example embodiments, the SMA element 400 has a cone shape as illustrated in FIG. 4A. The SMA element 400 has a narrow opening at a narrow end 402 and a wide opening at a wide end 404. As more clearly shown in FIG. 4B, the SMA element 400 may have a length (L) extending from the narrow end 402 to the wide end 404. The SMA element 400 has an inner diameter (Di) at the narrow end 402 and an outer diameter (Do) close to the wide end 404, which is large than diameter (Di). The wall 406 of the SMA device 400 has a thickness (t). In some example embodiments, the angle (α) between the inner surface 408 of the wall 406 and a vertical axis 410 extending through the wall 406 ranges between approximately 40° and approximately 90°. The particular angle (α) may depend on the particular SMA material, forces required to cause displacement, amount of displacement needed, and the desired lifecycle of the SMA element 400. The other parameters, i.e., the length (L), the inner diameter (Di), and the outer diameter (Do), may be selected based on the particular application and factors such as the diameter of a tubing (e.g., the tubing 102 of FIGS. 1A-1C). For example, the SMA element 400 may be made from a material such as NiTiPd alloy.

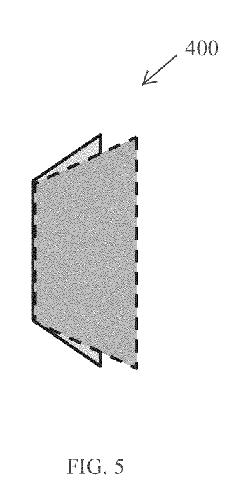

FIG. 5 illustrates outline views of two states of the shape memory alloy element 400 of FIGS. 4A-4B according to an example embodiment. For example, the solid outline of the SMA element 400 in FIG. 5 may correspond to the deformed shape of the SMA element 400, and the dotted outline shape may correspond to the SMA element 400 in a pre-deformed state to which the SMA element 400 returns upon being heated to above the transition temperature (e.g., to above 180 degrees C.) of the SMA element 400. Alternatively, the dotted outline of the SMA element 400 in FIG. 5 may correspond to the deformed shape of the SMA element 400, and the solid outline shape may correspond to the SMA element 400 in a pre-deformed state to which the SMA element 400 returns upon being heated to above the transition temperature (e.g., above 180 degrees C.) of the SMA element 400.

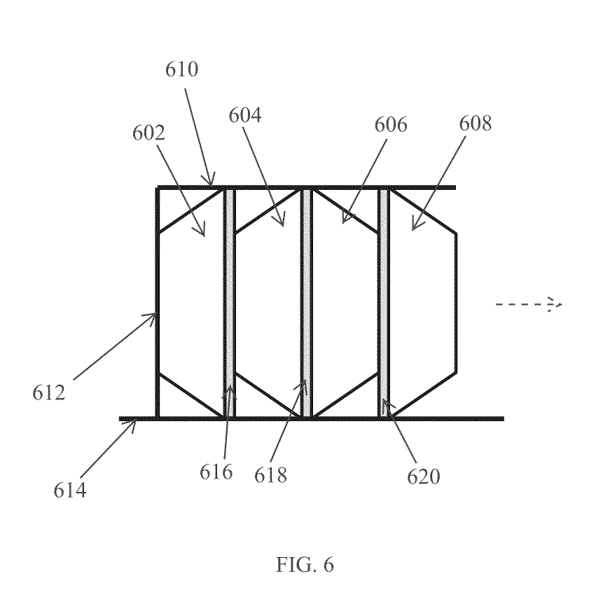

FIG. 6 illustrates a series of the shape memory alloy elements of FIGS. 4A-4B according to an example embodiment. In some example embodiments, FIG. 6 illustrates a close up view of the actuator device 100, 200, 300 showing a portion of the SMA device 108, 208, 308 respectively. For example, an enclosure 610 may enclose SMA elements 602, 604, 606, 608. To illustrate, the SMA elements 602, 604, 606, 608 may be positioned on a tubing surface 614. The SMA element 602 may abut against a rear wall 612 of the enclosure 610. For example, the narrow end of the SMA element 612 may abut against the rear wall 612, and the wide end of the SMA element 602 may abut against an optional washer 616 that separates the SMA element 602 from the SMA element 604. The wide end of the SMA element 604 abuts against another optional washer 618 that separates the SMA element 604 from the SMA element 606 that has a narrow end abutted against an optional washer 620. In some example embodiments, the narrow end of the SMA element 608 may abut against a valve, such as the valve 110, 210, 310. Alternatively, the narrow end of the SMA element 608 may abut against a washer or another SMA element.

In some example embodiments, the SMA elements 602, 604, 606, 608 may correspond to the SMA element 400 of FIGS. 4A and 4B. For example, the SMA elements 602, 604, 606, 608 may expand in the direction of the dotted arrow shown in FIG. 6 when the SMA elements 602, 604, 606, 608 are heated to above their transition temperature. Alternatively, the SMA elements 602, 604, 606, 608 may contract against the direction of the dotted arrow when heated to above their transition temperature. The SMA elements 602, 604, 606, 608 may be heated to above their transition temperature by electrical heating as described with respect to FIG. 3, by fluid flowing through a tubing as described with respect to FIG. 1A to FIG. 3, or as a result of heat transfer from a reservoir.

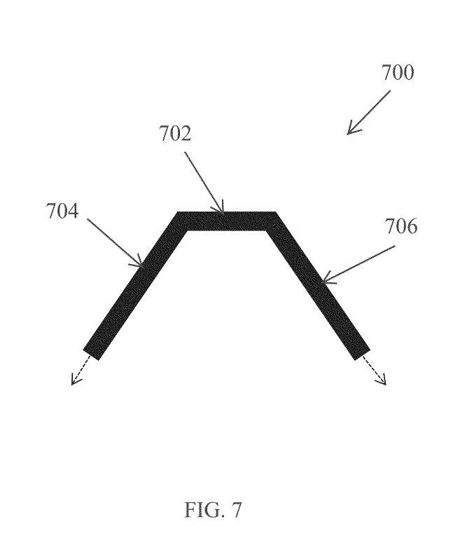

FIG. 7 illustrates a cross-sectional view of a shape memory alloy (SMA) element 700 that may be used in the actuator device of FIGS. 1A-C, FIGS. 2A-B and FIG. 3 according to another example embodiment. The SMA element 700 includes a horizontal member 702 and legs 704, 706. The legs 704, 706 extend down from the horizontal member at slanted angles. For example, the legs 704, 706 may extend down at the same angle, with respect to a vertical axis, as the angle (α) between the wall 406 and the vertical axis 410 shown in FIG. 4B.

In some example embodiments, the legs 704, 706 may lengthen in the directions shown by the dotted arrows in response to an increase in the temperature of the SMA element 700 above the transition temperature (e.g., above 180 degrees Celsius) of the SMA element 700. Alternatively, the legs 704, 706 may shorten in response to an increase in the temperature of the SMA element 700 above the transition temperature of the SMA element 700.

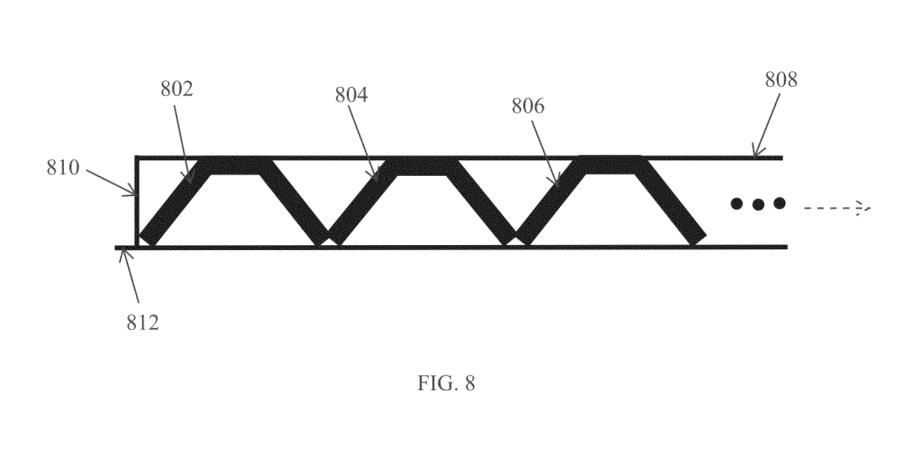

FIG. 8 illustrates series of the shape memory alloy element of FIG. 7 according to an example embodiment. In some example embodiments, FIG. 8 illustrates a close up view of the actuator device 100, 200, 300 showing a portion of the SMA device 108, 208, 308, respectively. For example, an enclosure 808 may enclose SMA elements 802, 804, 806. To illustrate, the SMA elements 802, 804, 806 may be positioned on a tubing surface 812. The SMA element 802 may abut against a rear wall 810 of the enclosure 808 on one side and abut the SMA element 804 on the other side. The SMA element 804 may in turn abut against the SMA element 806. In some example embodiments, the SMA element 806 may abut against a valve, such as the valve 110, 210, 310. Alternatively, the SMA element 806 may abut against another SMA element.

In some example embodiments, the SMA elements 802, 804, 806 may expand in the direction of the dotted arrow shown in FIG. 8 when the SMA elements 802, 804, 806 are heated to above their transition temperature. Alternatively, the SMA elements 802, 804, 806 may contract against the direction of the dotted arrow when heated to above their transition temperature. The SMA elements 802, 804, 806 may be heated to above their transition temperature by electrical heating as described with respect to FIG. 3, by fluid flowing through a tubing as described with respect to FIG. 1A to FIG. 3, or as a result of heat transfer from a reservoir.

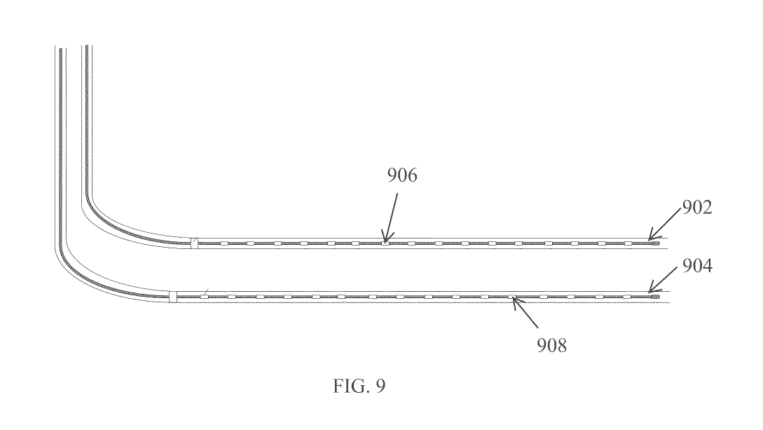

FIG. 9 illustrates a side view of injection and production wells in a SAGD operation that uses the actuator device of FIGS. 1A-C, FIGS. 2A-B and/or FIG. 3 according to an example embodiment. For example, a series of actuator devices 906 may be disposed around a tubing in an injection well 902. Similarly, a series of actuator devices 908 may be disposed around a tubing in a production well 904. For example, the actuator device 908 may be the actuator device 100 of FIGS. 1A-1C. As another example, the actuator device 906 may be the actuator device 200 of FIGS. 2A and 2B. Although FIG. 9 illustrates wells in a SAGD operation, the actuator devices 100, 200, 300 may be used in other systems and operations that can benefit from temperature based valve control.

Although some embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. An actuator device, comprising:
a shape memory alloy (SMA) device comprising a two way SMA element transformable from a deformed shape to a pre-deformed shape at a temperature of the SMA element that is above a transition temperature of the SMA element;
a valve having an opening therethrough, wherein the valve is moveable between an open position and a closed position; and
a biasing element, wherein the valve is positioned between the SMA device and the biasing element, wherein the SMA element is substantially cone-shaped, and wherein a wall of the SMA element is slanted down at an angle that is between approximately 40 degrees and approximately 90 degrees relative to a vertical axis extending through the wall.

2. The actuator device of claim 1, further comprising an enclosure disposed around the SMA device, the valve, and the biasing element, the enclosure having a second opening, wherein the valve is in the open position when the opening of the valve and the second opening of the enclosure are aligned with each other, and wherein the valve is in the closed position when the opening of the valve and the second opening of the enclosure are fully misaligned with each other.

3. The actuator device of claim 2, wherein the valve is slidable from the open position to the closed position in response to an expansion of the SMA element at the temperature of the SMA element that is above the transition temperature of the SMA element.

4. The actuator device of claim 2, wherein the valve is slidable from the open position to the closed position in response to a contraction of the SMA element at the temperature of the SMA element that is above the transition temperature of the SMA element.

5. The actuator device of claim 2, wherein the valve is slidable from the closed position to the open position in response to an expansion of the SMA element at the temperature of the SMA element that is above the transition temperature of the SMA element.

6. The actuator device of claim 2, wherein the valve is slidable from the closed position to the open position in response to a contraction of the SMA element at the temperature of the SMA element that is above the transition temperature of the SMA element.

7. The actuator device of claim 1, wherein the valve is slidable from the open position to the closed position in response to a transformation of the SMA element from the deformed shape to the pre-deformed shape.

8. The actuator device of claim 1, wherein the valve is slidable from the closed position to the open position in response to a transformation of the SMA element from the deformed shape to the pre-deformed shape.

9. The actuator device of claim 1, wherein the transition temperature of the SMA element is above 180 degrees Celsius.

10. The actuator device of claim 1, wherein the SMA device comprises a second SMA element, wherein the second SMA element is substantially cone-shaped, and wherein a narrow end of the second SMA element abuts against a wide end of the SMA element.

11. The actuator device of claim 1, wherein the SMA device comprises a second SMA element and a washer, wherein the second SMA element is substantially cone-shaped, wherein a wide opening of the SMA element abuts against the washer on a first side of the washer, and wherein a narrow end of the second SMA element abuts against the washer on a second side of the washer.

12. The actuator device of claim 1, wherein the actuator device has an annular shape.

13. An actuator device disposed annularly around a tubing, the actuator device comprising:
a shape memory alloy (SMA) device comprising a two way SMA element transformable from a deformed shape to a pre-deformed shape at a temperature of the SMA element that is above a transition temperature of the SMA element;
a valve having an opening therethrough, wherein the valve is moveable between an open position and a closed position;
a biasing element, wherein the valve is positioned between the SMA device and the biasing element, wherein the SMA element is substantially cone-shaped, and wherein a wall of the SMA element is slanted down at an angle that is between approximately 40 degrees and approximately 90 degrees relative to a vertical axis extending through the wall, wherein, when the SMA element transforms from the deformed shape to the deformable shape, the SMA element pushes the valve element toward the bias element such that the opening of the valve aligns with an opening of the tubing.

14. The actuator device of claim 13, further comprising an enclosure disposed around the SMA device, the valve, and the biasing element, wherein the enclosure immovably attached to the outer surface of the tubing, wherein the valve is in the open position when the opening of the valve, the opening of the tubing, and an opening of the enclosure are aligned with each other, and wherein the valve is in the closed position when the opening of the valve is fully misaligned with one or both of the opening of the tubing or the opening of the enclosure.

15. The actuator device of claim 14, wherein the valve is slidable from the open position to the closed position in response to a transformation of the SMA element from the deformed shape to the pre-deformed shape.

16. The actuator device of claim 14, wherein the valve is slidable from the closed position to the open position in response to a transformation of the SMA element from the deformed shape to the pre-deformed shape.

17. The actuator device of claim 14, wherein the temperature of the SMA element is increased to above the transition temperature by a transfer of heat from a fluid flowing through the tubing.

18. The actuator device of claim 14, wherein the temperature of the SMA element is increased to above the transition temperature by electrically heating the SMA element.

19. The actuator device of claim 14, wherein the SMA device comprises a second SMA element, wherein the second SMA element is substantially cone-shaped, and wherein a narrow end of the second SMA element abuts against a wide end of the SMA element.

20. The actuator device of claim 1, wherein the SMA device comprises a second SMA element and a washer, wherein the second SMA element is substantially cone-shaped, wherein a wide opening of the SMA element abuts against the washer on a first side of the washer, and wherein a narrow end of the second SMA element abuts against the washer on a second side of the washer.
